(19) United States
(12) Patent Application Publication
(10) Pub. No.: US 2026/0023153 A1
(43) Pub. Date: Jan. 22, 2026

(54) ADAPTIVE FAN NOISE SUPPRESSION FOR TRAFFIC RADAR SYSTEMS

(71) Applicant: Applied Concepts, Inc., Richardson, TX (US)

(72) Inventors: Stanley A. Walker, Flower Mound, TX (US); Steven F. Hocker, Gardner, TX (US); Zhigang Jin, Plano, TX (US); John C. Miller, Lewisville, TX (US)

(73) Assignee: Applied Concepts, Inc., Richardson, TX (US)

(21) Appl. No.: 19/339,819

(22) Filed: Sep. 25, 2025

Related U.S. Application Data
(63) Continuation of application No. 18/128,331, filed on Mar. 30, 2023, now Pat. No. 12,436,232.
(60) Provisional application No. 63/390,927, filed on Jul. 20, 2022.

(51) Int. Cl. G01S 7/28

(52) U.S. Cl. CPC G01S 7/2813

(57) ABSTRACT

A system for processing data, comprising a signal processing system configured to receive and process a reflected wireless data signal from a remote source and a noise suppression system configured to receive the wireless data signal and to detect and suppress harmonic components associated with reflected noise from a local source from the wireless data signal.

### RELATED APPLICATIONS

The present application claims priority to and benefit of U.S. Provisional patent application No. 63/390,927, filed Jul. 20, 2022, which is hereby incorporated by reference for all purposes as if set forth herein in its entirety.

### TECHNICAL FIELD

The present disclosure relates generally to radar speed detection devices and systems, and more specifically to a system and method for adaptive fan noise suppression for traffic radar systems.

### BACKGROUND OF THE INVENTION

Noise sources can cause radar system misoperation and affect reliability.

### SUMMARY OF THE INVENTION

A system for processing data is disclosed that has a signal processing system that receives and processes a wireless data signal, such as a reflected radar signal that is generated by the signal processing system. A fan noise suppression system receives the wireless data signal and detects and suppresses harmonic components associated with reflected fan noise, such as by electromagnetic frequency reflected by the fan or other structures, from the wireless data signal.

A system for processing data is disclosed that has a signal processing system that receives and processes a reflected wireless data signal from a remote source. A noise suppression system receives the wireless data signal and detects and suppresses harmonic components associated with reflected noise from a local source from the wireless data signal.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system 100 for adaptive fan noise suppression for traffic radar systems, in accordance with an example embodiment of the present disclosure; and

FIG. 2 is a diagram of an algorithm 200 for adaptive fan noise suppression for traffic radar systems, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

Radar systems with antennas that are installed inside vehicles will typically have some of the radar energy reflected off of the windshield and into the dash/console area. The scattered signals are prone to false target returns caused by AC blowers, fuel pumps or any constant mechanical motion device that can provide a Doppler return signal. The signal return from the rotating blades of an AC blower typically appears as a series of three or four targets that are harmonically related to each other. The problem is further complicated by the fact that the fan speed tends to change due to either user input or an automatic climate control system, and the power supply can also generate various frequency noise components that can migrate into the systems components and into other wireless signals.

To address this previously unidentified problem, the present disclosure provides an automatic system and algorithm for suppressing fan noise and other related noise, which requires no inputs by the user other than selection of user options from a user interface device. The present disclosure is fully adaptive to allow for automatic fan noise suppression even if the fan speed changes.

Fan noise and other local reflected noise can be differentiated from a normal Doppler target signal by the presence of even/odd harmonics. Therefore, a fan signal whose fundamental harmonic frequency is at N hertz will also have harmonics located at 2*N, 3*N, 4*N hertz and so on. Fan noise signal strength is also typically limited and constant relative to normal Doppler signals.

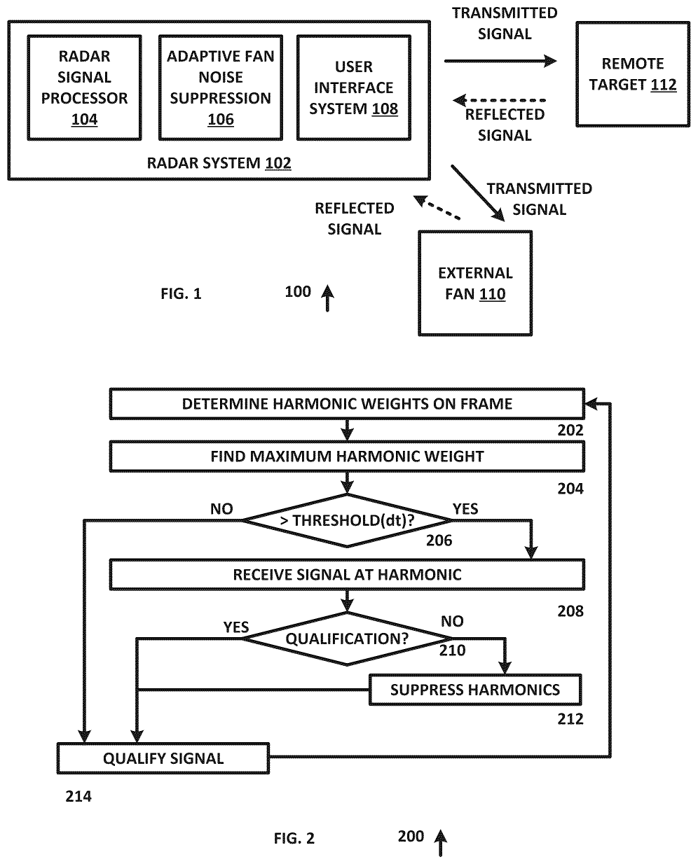

FIG. 1 is a diagram of a system 100 for adaptive fan noise suppression for traffic radar systems, in accordance with an example embodiment of the present disclosure. System 100 includes radar system 102, radar signal processor 104, adaptive fan noise suppression system 106, user interface system 108, external fan 110 and remote target 112, each of which can be implemented in hardware or a suitable combination of hardware and software.

Radar system 102 can include one or more components and sub-systems that are used for generating a transmitted electromagnetic signal, receiving a reflected electromagnetic signal and for performing other suitable functions as discussed and described herein. Radar system 102 can include one or more processors for performing analog and digital signal processing, for generating user displays and for other suitable purposes.

Radar signal processor 104 can be implemented as one or more algorithms operating on a processor, either alone or in conjunction with special purpose digital and analog data processing hardware systems, which cause the processor and any associated components to process radar signals. In one example embodiment, radar signal processor 104 can perform frequency domain analysis on electromagnetic signals, such as by performing a Fast Fourier Transform to identify frequency components (also known as bins) and associated signal strength components, on a frame by frame basis or in other suitable manners. As used herein, a frame can include a pre-defined collection of radar data and is on-going or continuous, or other suitable radar data such as individual sets of Fourier-transformed data. The data can be stored in a buffer as a series of time steps in order to facilitate processing, and selected processed data can be used in conjunction with statistical processing, signal processing or in other suitable manners.

Adaptive fan noise suppression system 106 can be implemented as one or more algorithms operating on a processor, either alone or in conjunction with special purpose digital and analog data processing hardware systems, which cause the processor and any associated components to identify fan noise or other local noise sources that generate frequency components at a harmonic of a base frequency. In one example embodiment, the power and harmonic profile is measured and summed for each possible set of fan noise harmonics in the range of interest on a frame by frame basis. The power is the sum of each harmonic signal-to-noise measurement in the set that is reasonable for fan noise. In one example embodiment, previously-identified ranges for local reflected noise components can be entered as stored data, local reflected noise components can be identified as a function of signal strength and frequency profiles (where local reflected noise does not change as a function of vehicle speed or time, but changes as a function of radar signal strength), or other suitable processes can also or alternatively be used to identify expected or reasonable candidates for local reflected noise. The profile is the sum of the relative signal-to-noise measurements in the set that is reasonable for local noise. The total sum for each harmonic set that is measured can be referred to as the harmonic weight. If the harmonic weight is above a minimum threshold, then each harmonic can be filtered to prevent it from appearing on the user interface system 108 display. Legitimate target systems can be displayed when they exceed predetermined harmonic weight levels.

User interface system 108 can be implemented as one or more algorithms operating on a processor, which cause the processor to generate a user interface that includes data and one or more user interface controls. In one example embodiment, user interface system 108 can generate a prompt to allow a user to select fan noise suppression, can allow the user to stop using fan noise suppression, can display suspected fan noise or other noise components to a user and can perform other suitable functions. User interface system 108 can be used to indicate when only fan noise or other noise sources should be present, such as when a patrol vehicle is not presently in range of a remote target or directed at any moving vehicles, so as to allow the local noise sources to be detected when there are no potential remote target signals present.

External fan 110 is an example of a local noise source that is located in the vicinity of radar system 102. External fan 110 can receive reflected noise signals from the radar signal source, a second reflection of the reflected radar signal from a target, or other suitable reflected noise signals. Likewise, other noise sources can generate noise that is processed by adaptive fan noise suppression system 106.

Remote target 112 can be a moving vehicle or other suitable targets that are monitored for speed data or other suitable data. In one example embodiment, remote target 112 can change its distance and speed relative to the transmitting radar unit, which can result in reflected signals that can fall within a frequency range that overlaps with noise signals from external fan 110 or other local reflected noise signals.

In operation, system 100 allows local reflected noise signals to be identified and suppressed, to improve the ability to identify reflected signals from remote targets. System 100 thus prevents spurious target detection signals and confusion between targets and local noise.

FIG. 2 is a diagram of an algorithm 200 for adaptive fan noise suppression for traffic radar systems, in accordance with an example embodiment of the present disclosure. Algorithm 200 can be implemented in hardware or a suitable combination of hardware and software.

Algorithm 200 begins at 202, where the power and harmonic profile is measured and summed for each possible set of local reflected noise harmonics in the range of interest on a frame-by-frame basis. The local reflected noise can have a predetermined known frequency, a user-entered frequency, can be independently measured or other suitable processes can also or alternatively be used to determine the expected local reflected noise harmonics. In one example embodiment, radar data can be received in a series of predefined collections of data that are ongoing or continuous, or in other suitable manners. The values for each harmonic set that is measured can be referred to as the harmonic weight, and the harmonic weight data can be stored in an array or in other suitable data structures.

At 204, the array or other data structure is searched for the maximum harmonic weight. The index (N) of the maximum weight identifies the location of likely local reflected noise. Each harmonic then is located at N, 2N, 3N and 4N.

At 206, it is determined whether the harmonic weight is above a minimum threshold. If so, then the algorithm proceeds to 208 where if one or more remote targets appear at the same frequency as any of the harmonics, it will become a candidate for qualification if it has a strength that is a pre-defined level above the level of the harmonic. This is determined at 210 and if a signal's strength is above the pre-defined level, the algorithm proceeds to 214 for qualification as a remote target. If the test at 210 is not above the pre-defined level, the algorithm proceeds to 212.

At 212, the suppression algorithm filters each harmonic at N, 2N, 3N, 4N and at other suitable harmonics before proceeding to 214 for remote-target qualification. Once the qualification operation is complete, the algorithm proceeds to 202. Likewise, a separate training mode and speed detection mode can be used to facilitate training and speed detection, or other suitable processes can also or alternatively be used.

In operation, algorithm 200 can be used for adaptive fan noise suppression for traffic radar systems. While algorithm 200 is shown as a flow chart, a person of skill in the art will recognize that it can also or alternatively be implemented using objected oriented programming, as a state diagram, as a ladder diagram, in other suitable manners, and on one or more processors.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1-18. (canceled)

19. A method for processing data, comprising:
receiving a reflected wireless data signal from a remote source at an antenna and generating an electrical signal;
processing the electrical signal to generate harmonic components;
identifying a frequency of a local reflected noise signal;
determining whether the frequency of the local reflected noise signal corresponds to a frequency of one or more of the harmonic components; and
suppressing the frequency of one or more of the harmonic components below a threshold associated with the local reflected noise signal.

20. The method of claim 19 wherein processing the electrical signal to generate harmonic components comprises processing a frame of the electrical data signal.

21. The method of claim 19 further comprising processing the reflected wireless data signal to generate a frame of frequency data.

22. The method of claim 19 further comprising processing the electrical signal to identify one or more harmonic weights.

23. The method of claim 19 wherein processing the electrical signal to generate harmonic components comprises processing a frame of the electrical data signal and processing the frame of the electrical data signal to identify a maximum harmonic weight.

24. The method of claim 19 wherein processing the electrical signal to generate harmonic components comprises processing a frame of the electrical data signal and processing the frame of the electrical data signal to identify whether a maximum harmonic weight has exceeded a threshold.

25. The method of claim 19 wherein processing the electrical signal to generate harmonic components comprises processing a frame of the electrical data signal and processing the frame of the electrical data signal to identify whether a maximum harmonic weight has exceeded a threshold for a predetermined period of time.

26. A method for processing data, comprising:
receiving a reflected wireless data signal from a remote source;
converting the wireless data signal into a plurality of frequency bins;
detecting one or more harmonic components in the frequency bins that are associated with local reflected noise; and
suppressing the detected one or more harmonic components.

27. The method of claim 26 wherein converting the wireless data signal into a plurality of frequency bins comprises converting a frame of the wireless data signal into the plurality of frequency bins.

28. The method of claim 26 further comprising processing the wireless data signal to identify one or more harmonic weights.

29. The method of claim 26 further comprising processing the wireless data signal to identify one or more maximum harmonic weights.

30. The method of claim 26 further comprising processing the wireless data signal to identify whether a maximum harmonic weight has exceeded a threshold.

31. The method of claim 26 further comprising processing the wireless data signal to identify whether a maximum harmonic weight has exceeded a threshold for a predetermined period of time.

32. A method for processing data, comprising:
transmitting a radio frequency signal;
receiving a reflected radio frequency signal from a remote target;
processing the reflected radio frequency signal to generate an electrical data signal; and
suppressing harmonic components of the electrical data signal below a threshold associated with noise from a local reflection of a structure.

33. The method of claim 32 further comprising processing a frame of the electrical data signal into a plurality of frequency components.

34. The method of claim 32 further comprising processing a frame of the electrical data signal to identify one or more harmonic weights of associated with the noise in the frequency bins.

35. The method of claim 32 further comprising processing a frame of the electrical data signal to identify a maximum harmonic weight associated with fan noise.

36. The method of claim 32 further comprising processing a frame of the electrical data signal to identify whether a maximum harmonic weight has exceeded a threshold.

37. The method of claim 32 further comprising processing a frame of the electrical data signal to identify whether a maximum harmonic weight has exceeded a threshold for a predetermined period of time.

38. The method of claim 19 wherein the local reflected noise is received from an attached structure.
